(19) United States
(12) Patent Application Publication
(10) Pub. No.: US 2024/0095963 A1
(43) Pub. Date: Mar. 21, 2024

(54) METHOD, APPARATUS AND STORAGE MEDIUM FOR IMAGE ENCODING/DECODING

(71) Applicant: Electronics and Telecommunications Research Institute, Daejeon (KR)

(72) Inventors: Jooyoung LEE, Daejeon (KR); Se-Yoon JEONG, Daejeon (KR); Youn-Hee KIM, Daejeon (KR); Jin-Soo CHOI, Daejeon (KR)

(73) Assignee: Electronics and Telecommunications Research Institute, Daejeon (KR)

(21) Appl. No.: 18/463,051

(22) Filed: Sep. 7, 2023

(30) Foreign Application Priority Data
Sep. 8, 2022 (KR) 10-2022-0114099
Sep. 6, 2023 (KR) 10-2023-0118490

(51) Int. Cl. G06T 9/00; G06T 3/40

(52) U.S. Cl. CPC G06T 9/00; G06T 3/40

(57) ABSTRACT

Disclosed herein are a method, apparatus, and storage medium for image encoding/decoding. Selective compression learning of latent representations for variable-rate image compression is used for the method, apparatus, and storage medium. A selective compression method that partially encodes latent representations in a completely generalized manner for deep-learning-based variable-rate image compression is disclosed in embodiments. The methods of the embodiments adaptively determine essential representation elements for compression at different target quality levels.

### CROSS REFERENCE TO RELATED APPLICATIONS

This application claims priority under 35 U.S.C 119(a) to Korean Patent Applications No. 10-2022-0114099, filed Sep. 8, 2022, and No. 10-2023-0118490, filed Sep. 6, 2023, in the Korean Intellectual Property Office, which are hereby incorporated by reference in their entireties into this application.

### BACKGROUND OF THE INVENTION

### 1. Technical Field

The present disclosure relates to a method, apparatus, and storage medium for image encoding/decoding. More particularly, the present disclosure provides a method, apparatus, and storage medium for image encoding/decoding for providing variable-rate image compression.

### 2. Description of the Related Art

Broadcast services with High-Definition (HD) resolution have spread worldwide through continuous development of information communication industry. As a result, a lot of users have become accustomed to high-definition, high-quality images and/or video.

In order to satisfy the users' demand for high image quality, many organizations accelerate development of next-generation image devices. Users' interest in Ultra-High Definition (UHD) TVs, which have resolution more than four times the resolution of Full HD (FHD) TVs, as well as High-Definition TVs (HDTVs) and FHD TVs has increased, and with the increasing interest, technology for image encoding/decoding for images having higher resolution and higher image quality is required.

Using such image compression technology, data for images may be effectively compressed, transmitted, and stored.

### SUMMARY OF THE INVENTION

An embodiment may provide an apparatus, method, and storage medium for variable-rate image compression.

An embodiment may provide an apparatus, method, and storage medium using selective compression learning of latent representations.

In an aspect, there is provided an image-encoding method that includes generating a latent representation using an input image, generating a quantized latent representation by performing adaptive quantization on the latent representation, deriving a set of selected elements of the quantized latent representation, and generating encoded information of the selected elements by performing entropy encoding on the set of the selected elements.

The quantized latent representation may be generated for a specific target quality level.

The set of the selected elements may be determined using a 3-dimensional (3D) binary mask.

The 3D binary mask may be generated using output of a specific layer of a hyper-decoder.

A hyperprior may be input to the hyper-decoder.

The encoded information of the selected elements may be generated using a parameter for a specific target quality level.

The parameter may include a scale parameter for the specific target quality level or a mean parameter for the specific target quality level.

In another aspect, there is provided an image-decoding method that includes generating a set of selected elements of a quantized latent representation by performing decoding on encoded information of the selected elements, converting the set of the selected elements into elements of a 3D-shaped latent representation, generating inversely quantized elements by performing inverse quantization on the elements of the 3D-shaped latent representation, and generating a reconstructed image by performing decoding on the inversely quantized elements.

The inverse quantization may be performed for a specific target quality level.

The elements of the 3D-shaped latent representation may be determined using a 3D binary mask.

The 3D binary mask may be generated using output of a specific layer of a hyper-decoder.

A hyperprior may be input to the hyper-decoder.

The set of the selected elements may be generated using a parameter for a specific target quality level.

The parameter may include a scale parameter for the specific target quality level or a mean parameter for the specific target quality level.

In a further aspect, a computer-readable storage medium for storing a bitstream for image decoding is provided, the bitstream may include encoded information of selected elements of a quantized latent representation, a set of the selected elements may be generated by performing decoding on the encoded information, the set of the selected elements may be converted into elements of a 3D-shaped latent representation, inversely quantized elements may be generated by performing inverse quantization on the elements of the 3D-shaped latent representation, and a reconstructed image may be generated by performing decoding on the inversely quantized elements.

The inverse quantization may be performed for a specific target quality level.

The elements of the 3D-shaped latent representation may be determined using a 3D binary mask.

The 3D binary mask may be generated using output of a specific layer of a hyper-decoder.

The set of the selected elements may be generated using a parameter for a specific target quality level.

The parameter may include a scale parameter for the specific target quality level or a mean parameter for the specific target quality level.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 illustrates the overall architecture of a method for Selective Compression of Representations (SCR) of an embodiment;

FIG. 2 illustrates a 3D binary mask generation process according to an example;

FIG. 3 illustrates important adjustment curves in eight target quality levels according to an example;

FIG. 4 illustrates masks generated for different target quality levels according to an example;

FIG. 5 illustrates average proportions of selected representation elements and average Bits per Pixel (BPP) according to an example;

FIG. 6 illustrates average proportions of reused representation elements from low to high quality levels according to an example;

FIG. 7 illustrates code for a representation selection operator and a reshaping operator according to an example;

FIG. 8 illustrates the structure of an encoding apparatus according to an embodiment;

FIG. 9 is a signal flowchart of an encoding method according to an embodiment;

FIG. 10 is a structural diagram of a decoding apparatus according to an embodiment; and

FIG. 11 is a flowchart of a decoding method according to an embodiment.

### DESCRIPTION OF THE PREFERRED EMBODIMENTS

Because the present disclosure may be variously changed and may have various embodiments, specific embodiments will be described in detail below with reference to the attached drawings. However, it should be understood that those embodiments are not intended to limit the present disclosure to specific disclosure forms and that they include all changes, equivalents or replacements included in the spirit and scope of the present disclosure.

Detailed descriptions of the following exemplary embodiments will be made with reference to the attached drawings illustrating specific embodiments as examples. These embodiments are described in detail so that those skilled in the art can easily practice the embodiments. It should be noted that the various embodiments are different from each other, but do not need to be mutually exclusive of each other. For example, specific shapes, structures, and characteristics described here may be implemented as other embodiments without departing from the spirit and scope of the present disclosure in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

In the drawings, similar reference numerals are used to designate the same or similar functions in various aspects. The shapes, sizes, etc. of elements in the drawings may be exaggerated to make the description clear.

In the present disclosure, terms such as “first” and “second” may be used to describe various components, but the components are not restricted by the terms. The terms are used only to distinguish one component from another component. For example, a first component may be named a second component without departing from the scope of the present disclosure. Likewise, a second component may be named a first component. The terms “and/or” may include combinations of a plurality of related described items or any of a plurality of related described items.

It will be understood that when a component is referred to as being “connected” or “coupled” to another component, the two components may be directly connected or coupled to each other, or intervening components may be present between the two components. In contrast, it will be understood that when a component is referred to as being “directly connected” or “directly coupled” to another component, no intervening components are present between the two components.

Also, components described in embodiments are independently shown in order to indicate different characteristic functions, but this does not mean that each of the components is formed of a separate piece of hardware or software. That is, the respective components are arranged and included separately for convenience of description. For example, at least two of the components may be integrated into a single component. Conversely, one component may be divided into multiple components so as to perform functions. An embodiment into which the components are integrated or an embodiment in which some components are separated is included in the scope of the present disclosure as long as it does not depart from the essence of the present disclosure.

The terms used in embodiments are merely used to describe specific embodiments and are not intended to limit the present disclosure. A singular expression includes a plural expression unless a description to the contrary is specifically pointed out in context. In embodiments, it should be understood that the terms such as “include” or “have” are merely intended to indicate that features, numbers, steps, operations, components, parts, or combinations thereof in the specification are present, and are not intended to exclude the possibility that one or more other features, numbers, steps, operations, components, parts, or combinations thereof will be present or added. That is, when a specific element is referred to as being “included”, elements other than the corresponding element are not excluded, but additional elements may be included in embodiments of the present disclosure or the technical scope of the present disclosure.

In embodiments, the term “at least one” may mean one of numbers of 1 or more, such as 1, 2, 3, and 4. In embodiments, the term “a plurality of” may mean one of numbers of 2 or more, such as 2, 3, and 4.

Some components of embodiments may not be essential components for performing the substantial functions in the present disclosure, and may be optional components merely for improving performance. Embodiments may be implemented by including only components essential to the embodiments, excluding components used merely to improve performance, and structures including only essential components and excluding optional components used merely to improve performance also fall within the scope of the embodiments.

Hereinafter, embodiments of the present disclosure will be described in detail with reference to the accompanying drawings such that those having ordinary knowledge in the technical field to which the present disclosure pertains can easily practice the embodiments. In the following description of the embodiments, detailed descriptions of known functions or configurations which are deemed to obscure the gist of the present specification will be omitted. Also, the same reference numerals are used to designate the same components throughout the drawings, and repeated descriptions of the same components will be omitted.

Hereinafter, an image may mean a single picture constituting video, or may indicate the video itself. For example, “encoding and/or decoding of an image” may mean “encoding and/or decoding of video”, or may mean “encoding and/or decoding of any one of images constituting the video”.

In embodiments, specific information, data, a flag, an index, an element, and an attribute may have their respective values. A value of “0” corresponding to each of the information, data, flag, index, element, and attribute may indicate false, logical false, or a first predefined value. In other words, the value of “0”, false, logical false, and a first predefined value may be used interchangeably with each other. A value of “1” corresponding to each of the information, data, flag, index, element, and attribute may indicate true, logical true, or a second predefined value. In other words, the value of “1”, true, logical true, and a second predefined value may be used interchangeably with each other.

When a variable such as i or j is used to indicate a row, a column, or an index, the value of i may be an integer equal to or greater than 0 or an integer equal to or greater than 1. In other words, in embodiments, each of a row, a column, and an index may be counted from 0 or may be counted from 1.

In embodiments, the term “one or more” or the term “at least one” may mean the term “a plurality of”. The term “one or more” or “at least one” may be replaced with the term “a plurality of”.

Recently, many image compression methods based on a neural network have produced superior results than existing tool-based conventional codecs.

However, most of the image compression methods based on a neural network are trained as separate models depending on different target bit rates, which may increase model complexity.

In response, some studies on learned compression, which supports variable bit rates with a single model, have been conducted. However, in these studies, additional network modules, layers, or inputs are required, and occasionally, complexity overhead may be caused, or sufficient encoding/decoding efficiency may not be provided.

In embodiments, a selective compression method that partially encodes latent representations in a completely generalized manner for deep-learning-based variable-rate image compression may be disclosed.

In embodiments, a “representation” may indicate a “latent representation”.

The methods of embodiments may adaptively determine essential representation elements for compression at different target quality levels.

To this end, first, a 3-dimensional (3D) importance map may be generated as the nature of input content in order to represent the underlying importance of representation elements. Then, the 3D importance map may be adjusted for various target quality levels using importance adjustment curves. Finally, the adjusted 3D importance map may be converted into a 3D binary mask in order to determine representation elements essential for compression.

The methods of embodiments may be easily integrated with existing compression models while having a negligible amount of increase in overhead. Also, the methods of embodiments may continuously enable variable-rate compression through simple interpolation of the importance adjustment curves between various quality levels.

The methods of embodiments may achieve compression efficiency comparable to the compression efficiency of individually trained reference compression models, and may reduce decoding time thanks to selective compression.

Neural-network-based (NN-based) image compression methods are actively being researched, and these methods may exhibit superior performance than existing tool-based compression methods, such as BPG and JPEG2000, from the aspect of Peak Signal-to-Noise Ratio (PSNR) Bjontegaard-Delta- (BD-) rate.

Some methods may achieve results comparable to the state-of-the-art codec called H.266 Intra-coding.

However, most of the existing deep-learning-based models are separately trained depending on different target compression levels, so multiple models having a large number of parameters may be required in order to support various compression levels.

In order to address this issue, several methods using conditional transform or adaptive quantization may be proposed.

However, most of these methods may require additional network modules, layers, or inputs, which may cause complexity overhead.

In embodiments, a new method for ‘Selective Compression of Representations’ (SCR), which performs entropy encoding/decoding only for partially selected latent representations, may be presented.

The selection of representations may be determined through a 3D binary mask generation process in a target-quality-adaptive manner.

In the 3D binary mask generation process of the SCR method, (i) a 3D importance map that has a fixed size and is independent of target quality levels may be generated for multi-channel feature maps (3D representations), (ii) the 3D importance map may be adjusted through channel-wise importance adjustment curves for a given target quality level, and (iii) a 3D binary mask may be generated by rounding off the adjusted 3D importance map.

The target-quality-independent 3D importance map may become target-quality-dependent after channel-wise importance adjustment.

The methods of embodiments may be integrated with an adaptive quantization scheme, in which case all elements may be optimized with selective compression of latent representations and adaptive quantization according to embodiments in an end-to-end manner.

In terms of architecture, the SCR method of embodiments uses only a single 1×1 convolutional layer in order to generate a 3D importance map and importance adjustment curves for a limited number of target quality levels, thereby minimizing overhead.

Also, the SCR method may continuously support variable-rate compression through simple nonlinear interpolation of importance adjustment curves between two discrete target quality levels.

Furthermore, the SCR method skips an entropy decoding process for a considerable amount of unselected representations, thereby reducing decoding time compared to reference compression models and a very lightweight adaptive quantization-based variable-rate method.

The encoding/decoding efficiency of the SCR method of embodiments may be higher than or similar to that of separately trained reference compression models for various target quality levels, and may be superior to the encoding/decoding efficiency of the adaptive quantization-based method.

The methods of embodiments may have the following characteristics:
The SCR method of embodiments may be the first NN-based variable-rate image compression method that selectively compresses representations in a completely generalized manner and a target-quality-adaptive manner. The SCR method of embodiments may provide compression efficiency comparable to the compression efficiency of the separately trained reference compression models.
The SCR method of embodiments may be applied to other image compression models without modifying the architecture thereof. Accordingly, the SCR method of embodiments may have high applicability. Very lightweight modules, including a single 1×1 convolutional layer and a small number of importance adjustment curves, may be integrated into the compression models. Thanks to selective compression, the SCR method of embodiments may reduce decoding time compared to the decoding time of the lightweight variable-rate model and reference compression models.
The SCR method of embodiments may continuously enable variable-rate compression through simple interpolation of importance adjustment curves between discrete quality levels in which selective compression is trained.

Overall Architecture

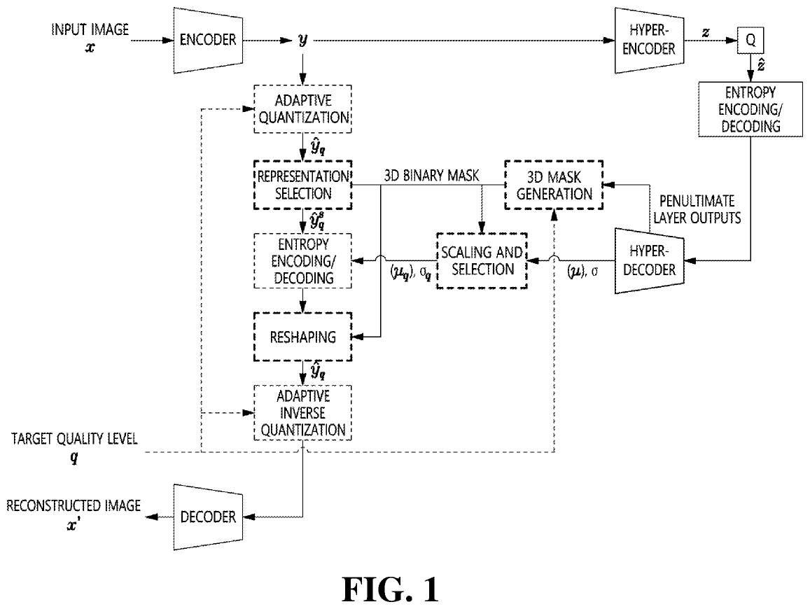

FIG. 1 illustrates the overall architecture of the SCR method of an embodiment.

In FIG. 1, the SCR method may be incorporated into a Hyperprior model.

In FIG. 1, elements for variable-rate compression may be marked with boxes with dotted lines.

Particularly, elements for selective compression may be highlighted with thick dotted lines.

As illustrated in FIG. 1, the SCR method of embodiments may be combined with adaptive quantization on the compression architectures, including a hyper-encoder and a hyper-decoder.

In embodiments, the SCR method has generality, and may be applied to reference compression models, such as Hyperprior, Mean-scale, and Context, in order to show the efficiency thereof.

In embodiments, a hyperprior may indicate a name of a model and may indicate additional information. Models such as the hyperprior model may use hyperprior additional information.

In the architecture including a hyper-encoder and a hyper-decoder, an input image x may be transformed into a representation y using an encoder network. The hyper-encoder and the hyper-decoder may be used to encode/decode distribution parameters for ŷ that is the quantized representation of y as additional information named hyperprior, and through the distribution parameters, ŷ may be entropy-encoded and entropy-decoded.

Then, the quantized representation ŷ may be reconstructed into an image x′ through a decoder network.

Two additional elements, that is, adaptive quantization and selective compression, are used on the base compression architecture, whereby variable-rate compression may be realized.

The selection of representation elements on the encoder side may be represented as shown in Equation (1) below:

ŷ_{q}^{s}=M(ŷ_{q},m(\hat{z},q)) (1)

Here, ŷ_{q} may be a quantized representation at a target quality level q.

Here, Equation (2) below may be satisfied for ŷ_{q}. That is, Equation (1) may be satisfied under the condition/definition of Equation (2):

ŷ_{q}=AdaQ_{q}(y) (2)

Here, ŷ_{q}^{s} may be a set of selected elements of ŷ_{q} for the given target quality level q.

AdaQ_{q}(•) may be a target-quality-adaptive quantization operator. Here, using a quantization vector QV_{q} for AdaQ_{q}(•), Equation (3) below may be satisfied:

AdaQ_{q}(y)=Round(y/QV_{q}) (3)

M(•) may be an element selection operator for ŷ_{q}.

m(\hat{z}, q) may represent a 3D binary mask generated for q and a hyperprior \hat{z}.

The representation y may be En(x) that is the output of the encoder network En(•) for the input image x illustrated in FIG. 1.

ŷ_{q}^{s} may be entropy-coded and entropy-decoded using an entropy model based on a target-quality-dependent distribution P_{q}.

The reconstructed image x′_{q} on the decoder side may be as shown in Equation (4) below:

x′_{q}=De(AdaIQ_{q}(y̆_{q})) (4)

Here, Equation (5) and Equation (6) may be satisfied. That is, Equation (4) may be satisfied under the conditions/definitions of Equation (5) and Equation (6):

AdaIQ_{q}(y̆_{q})=y̆_{q}−IQV_{q} (5)

y̆_{q}=Re(ŷ_{q}^{s},m(\hat{z},q)) (6)

Here, x′_{q} is the output of the decoder network De(•), and may be a reconstructed image for the given target quality level q.

AdaIQ_{q}(•) may be an adaptive inverse quantization operator for multiplying the input y̆_{q} by an inverse quantization vector IQV_{q}.

Re(•) may be a reshaping operator that converts the selected elements ŷ_{q}^{s} in a 1D form into elements of a 3D-shaped representation by using the 3D binary mask m(\hat{z}, q). In this case, each of the elements that constructs ŷ_{q}^{s} in a 1D form is relocated in a position it was before a M(•) element selection process of the encoder.

For unselected elements, the reshaping operator Re(•) may place 0s in the corresponding positions.

Example code for M(•) and Re(•) will be disclosed later.

In Equation (3) and Equation (5), the vector dimensionality of QV_{q} and IQV_{q} may be C_{y}. C_{y} may be the number of channels in y. Therefore, quantization of y and inverse quantization of y̆_{q} may be performed for respective channels by the respective elements QV_{q} and IQV_{q}.

Generation of 3D Binary Mask

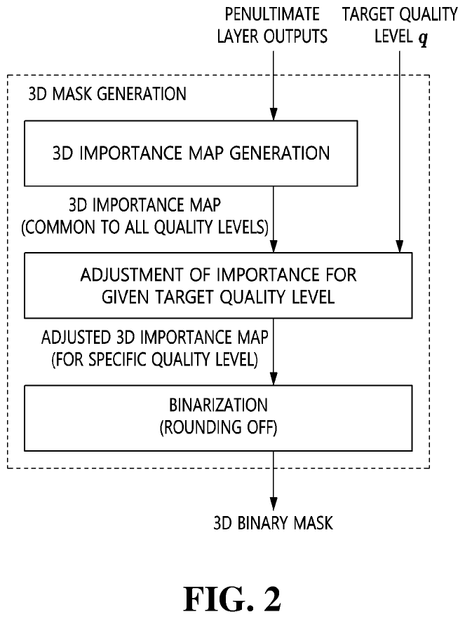

FIG. 2 illustrates a 3D binary mask generation process according to an example.

The 3D binary mask generation process may include the following three steps:
(1) generation of a 3D importance map
(2) adjustment of importance
(3) binarization

The 3D binary mask generation process may be defined as shown in Equation (7) below:

m(\hat{z},q)=B(im(\hat{z})^{γ}^{_{q}}) (7)

Here, im(\hat{z}) may be a 3D importance map generated through a hyper-decoder for a hyperprior \hat{z} that is used as input.

γ_{q} may be a parameter vector of the dimensionality N. γ_{q} may be defined as shown in Equation (8) below:

γ_{q}[γ_{q}¹,γ_{q}², . . . ,γ_{q}^{N}] (8)

N may be equal to C_{y}.

The parameters of γ_{q} may be learned in order to determine channel-wise importance adjustment curves for the given target quality q.

B(•) may be a binarization operator with rounding-off.

Generation of 3D Importance Map

The 3D importance map im(\hat{z}) may represent the underlying importance of each element in y.

The 3D importance map im(\hat{z}) may have values falling within a range between 0 and 1.

Without using a dedicated complex network for generating im(\hat{z}), the output of the penultimate convolutional layer (after activation) in the hyper-decoder may be fed into a single 1×1 convolutional layer in the mask generation module. Then, a clipping function may be applied in order to acquire importance values ranging from 0 to 1. That is, the clipping function may be applied to the output of the 1×1 convolutional layer. The input of a single 1×1 convolutional layer in the mask generation module may be an output of another layer in the hyper-decoder. For example, the input of a single 1×1 convolutional layer in the mask generation module may be a final output of a hyper-decoder or an output of a layer preceding than the penultimate layer.

Here, the 3D importance map may be generated depending on input images, rather than on target quality levels. Accordingly, the 3D importance map may represent the characteristics of y in terms of element-wise importance.

Importance Adjustment

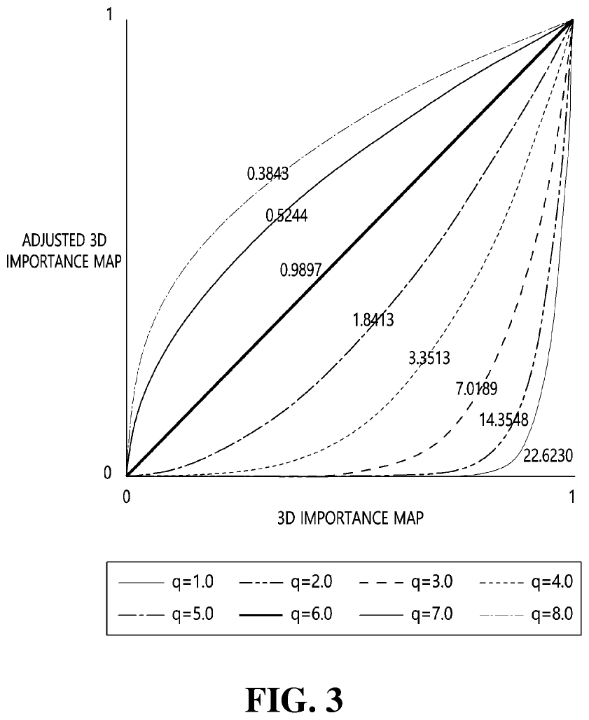

FIG. 3 illustrates importance adjustment curves in eight target quality levels according to an example.

The SCR method may be implemented on the Hyperprior model.

The actual importance of each representation element may vary depending on various target quality levels. For example, some representation elements corresponding to texture having high complexity in images may not be necessarily required for low-quality compression.

Accordingly, it may be natural to adjust the 3D importance map, which is used in common for all quality levels, depending on a specific target quality level.

To this end, a method of adjusting the 3D importance map im(\hat{z}) using importance adjustment curves for various target quality levels may be provided.

The importance adjustment curves may change the element values of im(\hat{z}) for respective channels.

The curvatures of the importance adjustment curves may be learned as the parameter vector γ_{q}. Here, q may be greater than 1 and less than N_{Q}. N_{Q} may be the total number of target quality levels used for learning.

The target quality may increase as q increases.

FIG. 3 may show some examples of importance adjustment curves.

In FIG. 3, the horizontal axis may represent the value of the input im(\hat{z}) to be adjusted. The vertical axis may represent the result of adjustment of the value of the input im(\hat{z}).

Also, the numbers on the importance adjustment curves may indicate the average values of trained vectors γ_{q} for the N_{Q} target quality levels.

Referring to FIG. 3, the importance adjustment curves for q greater than 6 may tend to amplify the elements of the input im(\hat{z}) in an average sense. Conversely, the importance adjustment curves for q less than 6 may attenuate the elements of the input im(\hat{z}). When q is 6, there may be little variation before and after the importance adjustment. Here, the average γ̅_{q} may be 0.9897.

Consequently, im(\hat{z}) may be more strongly amplified in an overall sense for higher target quality levels.

Conversely, im(\hat{z}) may be greatly attenuated for lower target quality levels. Accordingly, only a small number of elements having a value close to 1, among the elements of im(\hat{z}), may maintain the importance thereof.

The total number of vectors γ_{q} may be equal to N_{Q}. Accordingly, a total of N_{Q}×C_{y} parameters may be learned for all vectors γ_{q}.

In embodiments, N_{Q} may be set to 8. C_{y} may be set to C_{y} of the reference model.

Binarization

The 3D binary mask may be finally determined by a rounding operator. The rounding operator may be denoted as B(•).

Here, the values of “1” in the output 3D binary mask may indicate corresponding elements at the same location in y have been selected.

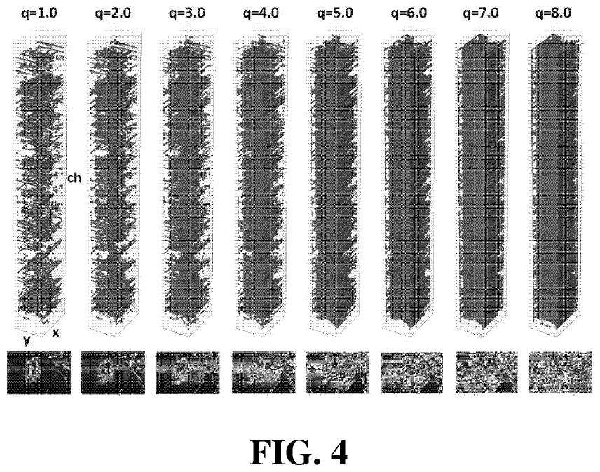

FIG. 4 illustrates masks generated for different target quality levels according to an example.

On the upper side of FIG. 4, sample masks of eight target quality levels are illustrated. The dark parts in the sample masks indicate representation elements selected by the 3D binary masks.

On the lower side of FIG. 4, the masks averaged along the channel axis are illustrated.

The higher the target quality, the more the representation elements that are selected in more complex regions.

For example, q may range from 1.0 to 8.0.

The SCR method of embodiments may be implemented on the Hyperprior model, and Kodim12 image of the Kodim12 image set may be used as an input sample. In the input sample, the darkly marked components may indicate the values of “1”.

For example, when q is set to 1.0 that is the lowest quality level in the SCR method, only 3.22% of the total elements may be selected. Also, as q increases, the proportion of selected elements may gradually increase.

For example, when q is 8.0, 43.39% of the representation elements may be selected.

Additionally, the SCR method of embodiments may use more representations in the high-complexity region, as shown in the masks averaged along the channel axis.

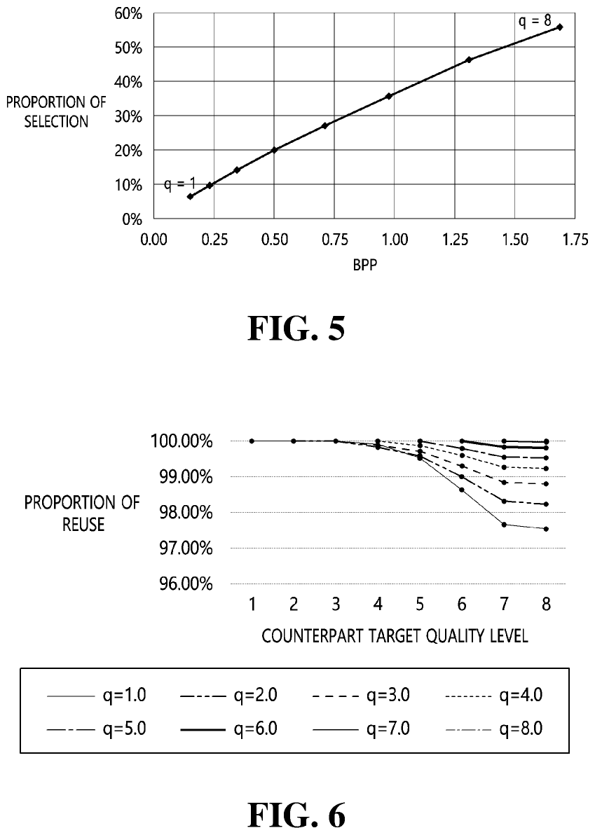

FIG. 5 illustrates average proportions of selected representation elements and average BPP according to an example.

In the embodiment with reference to FIG. 5, the test set may be the Kodak image set. The base model may be Hyperprior.

For example, for the entire Kodak image set, the average proportions of selected elements for the target quality levels from 1.0 to 8.0 may be 6.41%, 9.66%, 14.17%, 19.90%, 27.00%, 35.68%, 46.20%, and 55.81%, respectively. Here, as illustrated in FIG. 5, the average proportions may be almost linearly proportional to the average bits per pixel (BPP) values.

FIG. 6 illustrates average proportions of reused representation elements from low to high quality levels according to an example.

In the embodiment with reference to FIG. 6, the test set may be the Kodak image set. The base model may be Hyperprior.

FIG. 6 may show how many representations in a low target quality level are generally used (or selected) for target quality levels higher than that.

For example, in FIG. 6, the line corresponding to the case in which the target quality level q is 2 may indicate 100%, 99.8%, 99.6%, 99.0%, 98.3%, and 98.2% of representation elements. The representation elements that are selected when the target quality level q is 2 may be reused for the respective target quality levels q ranging from 3.0 to 8.0.

Referring to FIG. 6, 97.6% of the representation elements selected for the case in which q is 1.0 may be reused for the case in which q is 8.0.

Such reuse may indicate that the SCR method of embodiments actively takes a large portion of representation elements as common components for various target quality levels, rather than selecting representation elements separately for the different target quality levels.

Training

The SCR model may be trained in an end-to-end manner using the total loss formulated according to Equation (9) below:

[symbol]

=Σ_{q}R_{q}+λ_{q}*D_{q} (9)

Here, Equation (10) below may be satisfied for R_{q}. That is, Equation (9) may be satisfied under the condition/definition of Equation (10):

R_{q}=H_{q}(\tilde{y}_{q}^{s}|\tilde{z})+H(\tilde{z}) (10)

Here, R_{q} indicates the rate term for the target quality level q. D_{q} indicates the distortion term for the target quality level q.

λ_{q} indicates a parameter for adjusting the balance between the rate and the distortion. λ_{q} may be defined as shown in Equation (11) below:

λ_{q}=0.2·2^{q-8} (11)

D_{q} may be the Mean Squared Error (MSE) or Multi-Scale Structural SIMilarity (MS-SSIM) between the input image x and the reconstructed image x′_{q}.

In MS-SSIM-based optimization, the used distortion term D_{q} may be 3000 (1−MS-SSIM(x, x′_{q})).

H(•) may be a cross-entropy calculated for the quantized representations of y and z.

In the case of y, because the quantization and mask generation processes are different for respective target quality levels q, the cross-entropy H(•) may be used for the target quality level q, as shown in Equation (12) below:

$${H}_{q} ( {\tilde{y}}_{q}^{s} \vert \tilde{z} ) = \frac{1}{{N}_{x}} {\sum }_{i = 1}^{{N}_{q}^{s}} - {log}_{2} {P}_{q} ( {\tilde{y}}_{q , i}^{s} \vert \hat{z} ) \qquad ( 12 )$$

Here, Equation (13) below may be satisfied for \tilde{y}_{q}^{s}. That is, Equation (12) may be satisfied under the condition/definition of Equation (13):

\tilde{y}_{q}^{s}=M(y/QV_{q}+U(−0.5,0.5),\tilde{m}(\hat{z},q)) (13)

Nₓ may be the number of pixels in the input image x.

Nₛ may be the total number of selected elements {\tilde{y}_{q}^{s}}ᵢ₌₁^{N}^{_{q}}^{^{s}} of \tilde{y}_{q}^{s}.

The cross-entropy, H_{q}(\tilde{y}_{q}^{s}|\tilde{z}), of the selected representation elements may be calculated based on an approximate Probability Mass Function (PMF), P_{q}(•), in order to deal with the distribution of \tilde{y}_{q}^{s} that varies for different target quality levels.

Particularly, the estimated distribution parameters μ_{q} and σ_{q} of P_{q}(•) may be respectively set to M(μ/QV_{q}, m(\hat{z}, q)) and M(σ/QV_{q}, m(\tilde{z}, q)).

Here, the values of μ and σ may be acquired from base compression models.
μ may be a mean parameter. μ may be a mean parameter for the entropy model of the quantized representation f.
σ may be a scale parameter. σ may be a scale parameter for the entropy model of the quantized representation f.

For the Context-based model, the position-wise parameters μ_{q}^{(k,l)} and σ_{q}^{k,l)} may be acquired for each spatial coordinates (k, l) through M(μ^{(k,l})/QV_{q}, m(\hat{z}, q)^{(k,l)}) and M(σ^{(k,l)}/QV_{q},m(\hat{z}, q)^{(k,l)}), respectively.

When a zero-mean Gaussian-based model is used for P_{q}(•), μ_{q} may be ignored.

As in entropy-minimization-based compression models, a Gaussian distribution model convolved with a uniform distribution as an approximate PMF P_{q}(•) may be adopted.

Also, the representation with additive uniform noise U (−0.5, 0.5) may be used for training, rather than the rounded representation ŷ_{q}^{s} for inference. The representation with the additive uniform noise U (−0.5, 0.5) may be denoted as \tilde{y}_{q}^{s}.

In order to handle the instability in the training phase, which is caused by learning the binary representations of the mask, a stochastically generated mask \tilde{m}(•) may be used in the test phase, rather than using m(•).

The adjusted 3D importance map is simply rounded off for m(•), but \tilde{m}(•) may be constructed with randomly sampled binary representations by regarding each element value of the adjusted 3D importance map im(\hat{z})^{γ}^{_{q}} as the probability that the corresponding component of the output mask is “1”.

\tilde{m}(\hat{z}, q) may be generated as shown in Equation (14) below:

\tilde{m}(\hat{z},q)=B(im(\hat{z})^{γ}^{_{q}}+U(−0.5,0.5)) (14)

Discontinuity caused by the rounding off operator B(•) may be handled by bypassing gradients backwards.

In the actual implementation, training may be performed without using M(•) and Re(•). This is because the unselected representations may be excluded using Equation (15) for calculating R_{q} and because y̆_{q} may be acquired through AdaQ_{q}(y)·\tilde{m}(\hat{z}, q) in order to calculate D_{q}.

$${H}_{q} ( {\tilde{y}}_{q}^{s} \vert \tilde{z} ) = \frac{1}{{N}_{x}} {\sum }_{i} - {log}_{2} {P}_{q} ( {\tilde{y}}_{q , i} ) \cdot {\tilde{m} ( \hat{z} , q )}_{i} \qquad ( 15 )$$

Here, Equation (16) may be satisfied for \tilde{y}_{q}. That is, Equation (15) may be satisfied under the condition/definition of Equation (16):

\tilde{y}_{q}=y/QV_{q}+U(−0.5,0.5) (16)

Other training details will be described later.

Continuous Variable-Rate Compression

In order to support continuous variable-rate compression during the test, γ_{q} may be set by interpolation, as defined in Equation (17) below. Here, q may be a value between two discrete target quality levels.

$${γ}_{q} = \{ \begin{matrix}{γ}_{q} , & if q ∈ \{ 1 , 2 , … , {N}_{Q} \} \\ {γ}_{⌊ q ⌋}^{1 - ( q - ⌊ q ⌋ )} \cdot {γ}_{⌈ q ⌉}^{q - ⌊ q ⌋} , & otherwise\end{matrix} \qquad ( 17 )$$

For example, when q is 3.8, γ₃₈ may be set through element-wise multiplication of γ_{3.0}^{0.2} and γ_{4.0}^{0.8}.

QV_{q} and IQV_{q} vectors may also be interpolated in the same manner as described above. The interpolation may be nonlinear interpolation.

Code of Operator

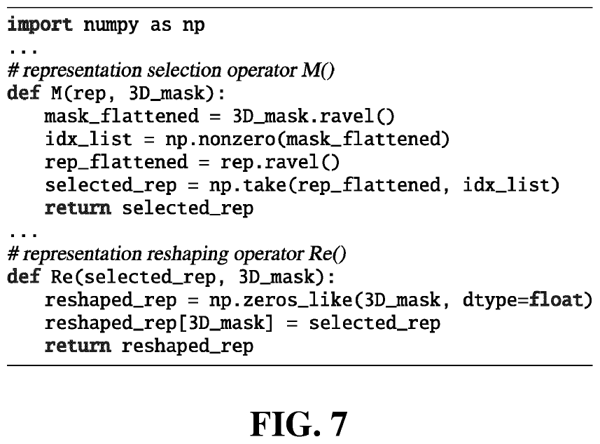

FIG. 7 illustrates the code of a representation selection operator and a reshaping operator according to an example.

In FIG. 7, code for implementing the selection operator M(•) and the reshaping operator Re(•) is illustrated.

These two modules may be used for the test phase. These two modules may not be necessarily required for training.

Training Details of SCR Method

For more stable and faster training, step-wise training including the following three steps may be adopted.
(1) In the first step, a fixed-rate compression model may be trained for high-quality compression. For example, in the case of high-quality compression, the target quality level q of a variable-rate model may be 8.0.
(2) In the second step, the trained fixed-rate compression model may be used as a pretrained model. An SCR variant model of the second step may be trained without selective compression in an end-to-end manner.
(3) In the third step, the SCR variant model of the second step trained without selective compression may be used as a pretrained model. The SCR full model of the third step may be trained in an end-to-end manner.

All of the training steps may be performed using an optimizer until performance of each of the steps sufficiently converges.

For example, the numbers of training iteration of the three steps may be 7 million, 1.2 million, and 1.2 million, respectively.

As the training data set, 51,141 patches, each having a size of 256×256, may be used after being cropped from the entire training set so as not to overlap each other. The batch size may be set to 8.

An initial learning rate may be set to 5×10⁻⁵. For the final 100,000 times of iteration, a learning rate of 2×10⁻⁶ may be used. The decrease in the learning rate may be performed for all training phases.

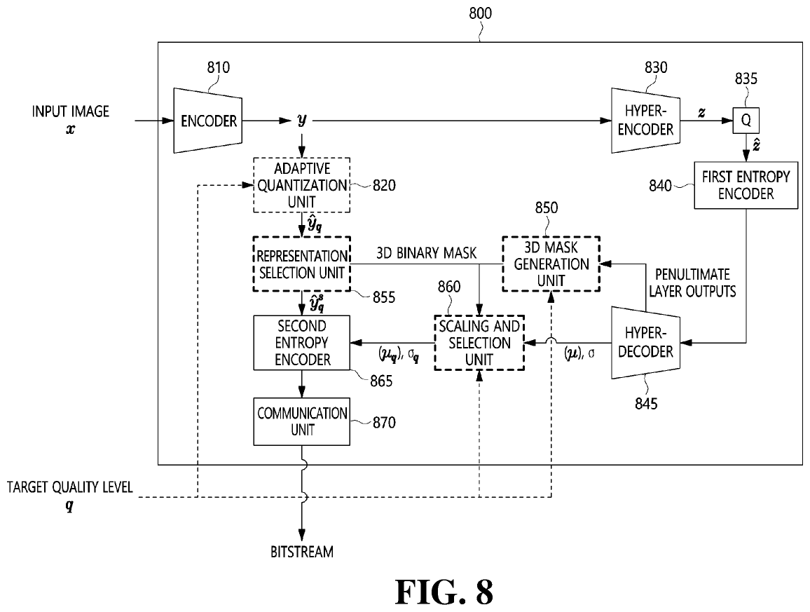

FIG. 8 illustrates the structure of an encoding apparatus according to an embodiment.

The encoding apparatus 800 may include an encoder 810, an adaptive quantization unit 820, a hyper-encoder 830, a quantization unit 835, a first entropy encoder 840, a hyper-decoder 845, a 3D mask generation unit 850, a representation selection unit 855, a scaling and selection unit 860, a second entropy encoder 865, and a communication unit 870.

The encoding apparatus 800 may generate a bitstream including information that is generated by performing encoding on an input image x.

At least some of the encoder 810, the adaptive quantization unit 820, the hyper-encoder 830, the quantization unit 835, the first entropy encoder 840, the hyper-decoder 845, the 3D mask generation unit 850, the representation selection unit 855, the scaling and selection unit 860, the second entropy encoder 865, and the communication unit 870 may be program modules, and may communicate with an external device or system. The program modules in the form of operating systems, application modules, and other program modules may be included in the encoding apparatus 800.

The program modules may be physically stored in various known memory devices. Also, at least some of these program modules may be stored in a remote memory device capable of communicating with the encoding apparatus 800.

The program modules may include a routine, a subroutine, a program, an object, a component, a data structure, and the like for executing a function or an operation according to an embodiment or for implementing an abstract data type according to an embodiment, but are not limited thereto.

The program modules may be configured with instructions or code executed by at least one processor of the encoding apparatus 800.

The encoding apparatus 800 may be implemented in a computer system including a computer-readable storage medium.

The storage medium may store at least one module required for operating the encoding apparatus 800.

The function related to communication of data or information of the encoding apparatus 800 may be performed by the communication unit 870.

For example, the communication unit 870 may transmit the bitstream to the decoding apparatus 1000 to be described later.

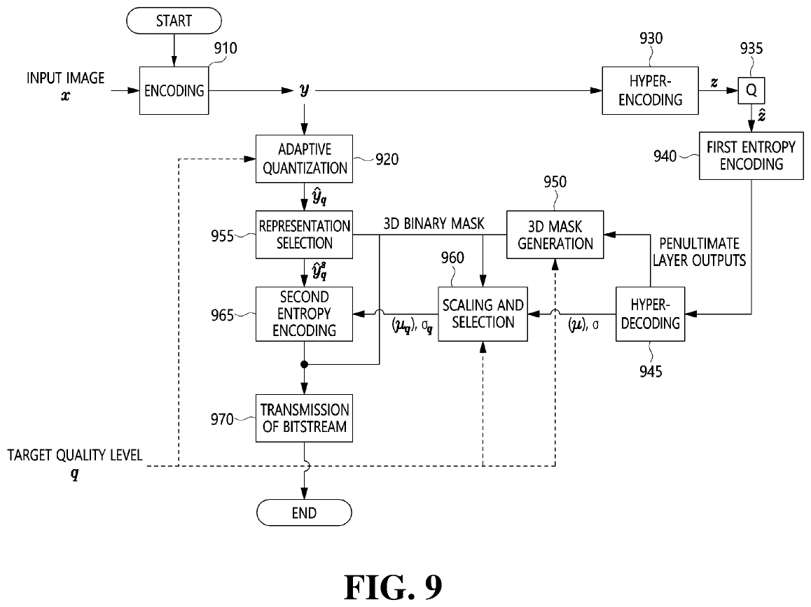

FIG. 9 is a signal flowchart of an encoding method according to an embodiment.

At step 910, the encoder 810 may generate a latent representation y using an input image x.

The encoder 810 performs encoding on the input image x, thereby generating the latent representation y.

At step 920, when a target quality level q is given, the adaptive quantization unit 820 performs adaptive quantization on the latent representation y, thereby generating a quantized latent representation ŷ_{q} at the target quality level q.

In embodiments, when a target quality level q is given to a specific component, this may mean that the target quality level q is input to the specific component. Alternatively, when a target quality level q is given to a specific component, this may mean that the specific component is generated for the target quality level.

For example, the quantized latent representation ŷ_{q} may be generated for a specific target quality level.

At step 930, the hyper-encoder 830 may generate a hyperprior latent z using the latent representation y.

At step 935, the quantization unit 835 may generate a quantized hyperprior latent \hat{z} using the hyperprior latent z.

The quantization unit 835 performs quantization on the hyperprior latent z, thereby generating the quantized hyperprior latent \hat{z}.

At step 940, the first entropy encoder 840 performs entropy encoding on the quantized hyperprior latent \hat{z}, thereby generating encoded information of the hyperprior.

A bitstream may include the encoded information of the hyperprior.

At step 945, the hyper-decoder 845 may generate output of the penultimate layer using the quantized hyperprior latent \hat{z}.

The hyper-decoder 845 may generate parameters using the quantized hyperprior latent \hat{z}. The parameters may include a scale parameter σ. The parameters may include a mean parameter μ.

At step 950, the 3D mask generation unit 850 may generate a 3D binary mask using the output of a specific layer of the hyper-decoder.

The specific layer may be the penultimate layer. The 3D mask generation unit 850 may generate the 3D binary mask using the output of the penultimate layer of the hyper-decoder.

In embodiments, a 3D mask may mean a 3D binary mask.

The quantized hyperprior latent \hat{z} may be input to the hyper-decoder. The hyper-decoder performs decoding on the quantized hyperprior latent \hat{z}, thereby generating the output of the penultimate layer.

When the target quality level q is given, the 3D mask generation unit 850 may generate a 3D binary mask for the target quality level q using the output of the penultimate layer.

At step 955, the representation selection unit 855 may derive a set of selected elements of ŷ_{q}, that is, ŷ_{q}^{s}, for the target quality level q using the quantized latent representation ŷ_{q} and the 3D binary mask at the target quality level q.

At step 960, when the target quality level q is given, the scaling and selection unit 860 may generate parameters for the target quality level q using the 3D binary mask and the parameters.

The parameters may include the scale parameter σ. The parameters may include the mean parameter μ.

The parameters for the target quality level q may include a scale parameter σ g for the target quality level q. σ_{q} may be generated based on σ.

The parameters for the target quality level q may include a mean parameter μ_{q} for the target quality level q. μ_{q} may be generated based on p.

At step 965, the second entropy encoder 865 performs entropy encoding on ŷ_{q}^{s}, which is the set of the selected elements of the quantized latent representation ŷ_{q} at the target quality level q, using the parameters for the target quality level q, thereby generating encoded information of the selected elements of the quantized latent representation ŷ_{q} at the target quality level q.

The bitstream may include the encoded information of the selected elements of the quantized latent representation ŷ_{q} at the target quality level q.

At step 970, the communication unit 870 may transmit the bitstream to the decoding apparatus 1000.

Descriptions and processing of information described above in the embodiments may also be applied to the information of the steps described with reference to FIG. 9.

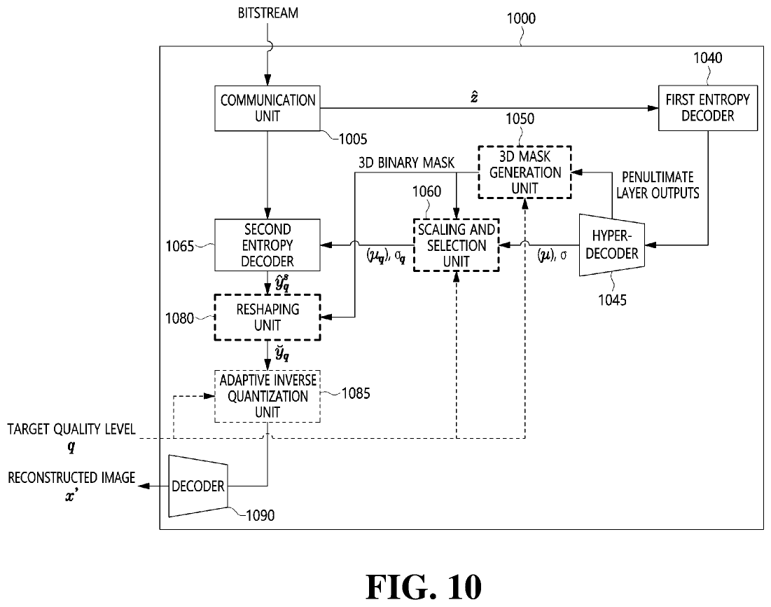

FIG. 10 is a structural diagram of a decoding apparatus according to an embodiment.

The decoding apparatus 1000 may include a communication unit 1005, a first entropy decoder 1040, a hyper-decoder 1045, a 3D mask generation unit 1050, a scaling and selection unit 1060, a second entropy decoder 1065, a reshaping unit 1080, an adaptive inverse quantization unit 1085, and a decoder 1090.

The decoding apparatus 1000 performs decoding on the encoded information of a bitstream, thereby generating a reconstructed image x′.

At least some of the communication unit 1005, the first entropy decoder 1040, the hyper-decoder 1045, the 3D mask generation unit 1050, the scaling and selection unit 1060, the second entropy decoder 1065, the reshaping unit 1080, the adaptive inverse quantization unit 1085, and the decoder 1090 may be program modules, and may communicate with an external device or system. The program modules in the form of operating systems, application modules, and other program modules may be included in the decoding apparatus 1000.

The program modules may be physically stored in various known memory devices. Also, at least some of these program modules may be stored in a remote memory device capable of communicating with the decoding apparatus 1000.

The program modules may include a routine, a subroutine, a program, an object, a component, a data structure, and the like for executing a function or an operation according to an embodiment or for implementing an abstract data type according to an embodiment, but are not limited thereto.

The program modules may be configured with instructions or code executed by at least one processor of the decoding apparatus 1000.

The decoding apparatus 1000 may be implemented in a computer system including a computer-readable storage medium.

The storage medium may store at least one module required for operating the decoding apparatus 1000.

The function related to communication of data or information of the decoding apparatus 1000 may be performed by the communication unit 1005.

For example, the communication unit 1005 may receive a bitstream from an encoding apparatus 800.

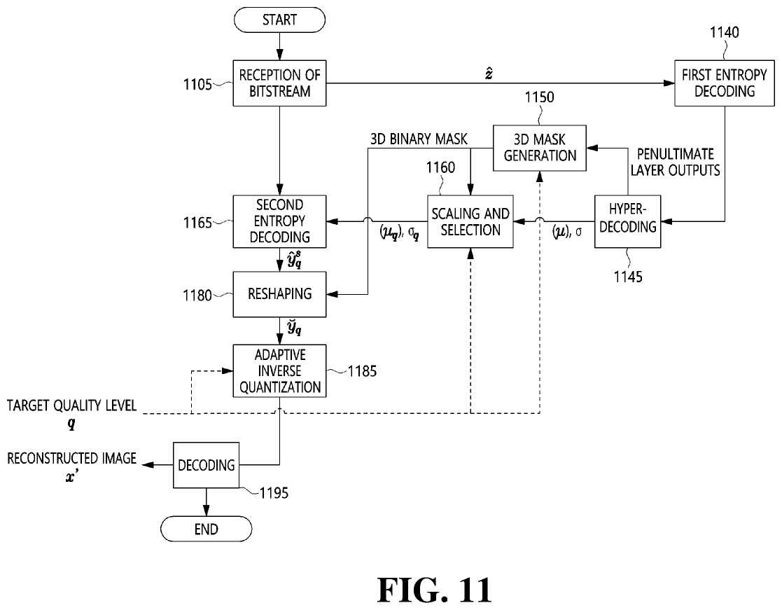

FIG. 11 is a flowchart of a decoding method according to an embodiment.

At step 1105, the communication unit 1005 may receive a bitstream from the encoding apparatus 800.

The bitstream may include encoded information of a hyperprior.

The bitstream may include encoded information of selected elements of a quantized latent representation ŷ_{q} at a target quality level q.

At step 1140, the first entropy decoder 1040 performs decoding on the encoded information of the hyperprior, thereby generating the quantized hyperprior latent \hat{z}.

At step 1145, the hyper-decoder 1045 may generate output of the penultimate layer using the quantized hyperprior latent \hat{z}.

The hyper-decoder 1045 may generate parameters using the quantized hyperprior latent \hat{z}. The parameters may include a scale parameter σ. The parameters may include a mean parameter μ.

At step 1150, the 3D mask generation unit 1050 may generate a 3D binary mask using the output of a specific layer of the hyper-decoder.

The specific layer may be the penultimate layer. The 3D mask generation unit 1050 may generate the 3D binary mask using the output of the penultimate layer of the hyper-decoder.

In embodiments, a 3D mask may mean a 3D binary mask.

The quantized hyperprior latent \hat{z} may be input to the hyper-decoder. The hyper-decoder performs decoding on the quantized hyperprior latent \hat{z}, thereby generating the output of the penultimate layer.

When the target quality level q is given, the 3D mask generation unit 1050 may generate a 3D binary mask for the target quality level q using the output of the penultimate layer.

At step 1160, when the target quality level q is given, the scaling and selection unit 1060 may generate parameters for the target quality level q using the 3D binary mask and the parameters.

The parameters may include the scale parameter σ. The parameters may include the mean parameter μ.

The parameters for the target quality level q may include a scale parameter σ g for the target quality level q. σ_{q} may be generated based on σ.

The parameters for the target quality level q may include a mean parameter μ_{q} for the target quality level q. μ_{q} may be generated based on μ.

At step 1165, the second entropy decoder 1065 performs decoding on the encoded information of the selected elements of the quantized latent representation ŷ_{q} at the target quality level q using the parameters for the target quality level q, thereby generating ŷ_{q}^{s} that is a set of the selected elements of the quantized latent representation ŷ_{q} at the target quality level q.

At step 1180, the reshaping unit 1080 may convert ŷ_{q}^{s}, which is the set of the selected elements of the quantized latent representation ŷ_{q} at the target quality level q, into the elements ye of a 3D-shaped latent representation at the target quality level q using the 3D binary mask.

Here, ŷ_{q}^{s}, which is the set of the selected elements of the quantized latent representation ŷ_{q} at the target quality level q, may have a 1D form.

At step 1185, the adaptive inverse quantization unit 1085 performs inverse quantization on the elements y̆_{q} of the 3D-shaped latent representation at the target quality level q, thereby generating inversely quantized elements of the 3D-shaped latent representation.

Inverse quantization may be performed for the target quality level q.

At step 1195, the decoder 1090 performs decoding on the inversely quantized elements of the 3D-shaped latent representation, thereby generating a reconstructed image x′.

Descriptions and processing of information described above in the embodiments may also be applied to the information of the steps described with reference to FIG. 11.

The above-described embodiments may be performed in the encoding apparatus 800 and the decoding apparatus 1000 using the same method and/or corresponding methods. Also, a combination of one or more of the above-described embodiments may be used for image encoding and/or decoding.

The order in which the above-described embodiments are applied in the encoding apparatus 800 may be different from that in the decoding apparatus 1000. Alternatively, the order in which the above-described embodiments are applied in the encoding apparatus 800 and that in the decoding apparatus 1000 may be (at least partially) the same as each other.

In the above-described embodiments, although the methods have been described based on flowcharts as a series of steps or units, the present disclosure is not limited to the sequence of the steps, and some steps may be performed in a sequence different from that of the described steps or simultaneously with other steps. Further, those skilled in the art will understand that the steps shown in the flowchart are not exclusive and that other steps may be further included in the flowchart or one or more steps in the flowchart may be deleted without affecting the scope of the present disclosure.

The above-described embodiments include various aspects of examples. Not all possible combinations for indicating various aspects can be described, but those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented in the form of program instructions that can be executed by various computer components and may be recorded on a computer-readable storage medium. The computer-readable storage medium may include program instructions, data files, and data structures, either solely or in combination. The program instructions recorded on the computer-readable storage medium may have been specially designed and configured for the present disclosure, or may be known to or available to those who have ordinary knowledge in the field of computer software.

The computer-readable storage medium may include information used in the embodiments according to the present disclosure. For example, the computer-readable storage medium may include a bitstream, and the bitstream may include information described in the embodiments according to the present disclosure.

The bitstream may include computer-executable code and/or programs. The computer-executable code and/or programs may include information described in the embodiments and include syntax elements described in the embodiments. That is, the information and syntax elements described in the embodiments may be regarded as computer-executable code in the bitstream, and may be regarded as at least part of computer-executable code and/or programs represented as a bitstream.

The computer-readable storage medium may include a non-transitory computer-readable medium.

Examples of the computer-readable storage medium include hardware devices specially configured to store and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

There are provided an apparatus, method, and storage medium for variable-rate image compression.

There are provided an apparatus, method, and recording medium using selective compression learning of latent representations.

As described above, although the present disclosure has been described based on specific details such as detailed components and a limited number of embodiments and drawings, the embodiments are merely provided for overall understanding of the present disclosure, the present disclosure is not limited thereto, and those skilled in the art will practice various changes and modifications from the above description.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for image encoding, comprising:
generating a latent representation using an input image;
generating a quantized latent representation by performing adaptive quantization on the latent representation;
deriving a set of selected elements of the quantized latent representation; and
generating encoded information of the selected elements by performing entropy encoding on the set of the selected elements.

2. The method of claim 1, wherein the quantized latent representation is generated for a specific target quality level.

3. The method of claim 1, wherein the set of the selected elements is determined using a 3D binary mask.

4. The method of claim 3, wherein the 3D binary mask is generated using output of a specific layer of a hyper-decoder.

5. The method of claim 4, wherein a hyperprior is input to the hyper-decoder.

6. The method of claim 1, wherein the encoded information of the selected elements is generated using a parameter for a specific target quality level.

7. The method of claim 6, wherein the parameter includes a scale parameter for the specific target quality level or a mean parameter for the specific target quality level.

8. A method for image decoding, comprising:
performing decoding on encoded information of selected elements of a quantized latent representation, thereby generating a set of the selected elements;
converting the set of the selected elements into elements of a 3D-shaped latent representation;
generating inversely quantized elements by performing inverse quantization on the elements of the 3D-shaped latent representation; and
generating a reconstructed image by performing decoding on the inversely quantized elements.

9. The method of claim 8, wherein the inverse quantization is performed for a specific target quality level.

10. The method of claim 8, wherein the elements of the 3D-shaped latent representation is determined using a 3D binary mask.

11. The method of claim 10, wherein the 3D binary mask is generated using output of a specific layer of a hyper-decoder.

12. The method of claim 11, wherein a hyperprior is input to the hyper-decoder.

13. The method of claim 8, wherein the set of the selected elements is generated using a parameter for a specific target quality level.

14. The method of claim 13, wherein the parameter includes a scale parameter for the specific target quality level or a mean parameter for the specific target quality level.

15. A computer-readable storage medium for storing a bitstream for image decoding,
wherein:
the bitstream includes encoded information of selected elements of a quantized latent representation,
a set of the selected elements is generated by performing decoding on the encoded information,
the set of the selected elements is converted into elements of a 3D-shaped latent representation,
inversely quantized elements are generated by performing inverse quantization on the elements of the 3D-shaped latent representation, and
a reconstructed image is generated by performing decoding on the inversely quantized elements.

16. The computer-readable storage medium of claim 15, wherein the inverse quantization is performed for a specific target quality level.

17. The computer-readable storage medium of claim 15, wherein the elements of the 3D-shaped latent representation are determined using a 3D binary mask.

18. The computer-readable storage medium of claim 17, wherein the 3D binary mask is generated using output of a specific layer of a hyper-decoder.

19. The computer-readable storage medium of claim 15, wherein the set of the selected elements is generated using a parameter for a specific target quality level.

20. The computer-readable storage medium of claim 19, wherein the parameter includes a scale parameter for the specific target quality level or a mean parameter for the specific target quality level.
